(19) United States
(12) Patent Application Publication
(10) Pub. No.: US 2025/0392090 A1
(43) Pub. Date: Dec. 25, 2025

(54) POWER TOOL AND ELECTRICAL CONNECTOR THEREFOR

(71) Applicant: Black & Decker, Inc., New Britain, CT (US)

(72) Inventors: James STANDALOFT, Gateshead (GB); Thomas HEILIG, Frankfurt (DE); Tobias DEMANT, Wiesbaden (DE); Robert MIEBACH, Taunusstein (DE); Benjamin SCHRAMM, Eppenrod (DE); Manfred DROSTE, Grosskrotzenburg (DE)

(21) Appl. No.: 19/305,156

(22) Filed: Aug. 20, 2025

Related U.S. Application Data
(63) Continuation of application No. PCT/EP2023/084389, filed on Dec. 5, 2023.

(30) Foreign Application Priority Data
Dec. 7, 2022 (GB) 2218350.3

(51) Int. Cl. H01R 35/04; B25F 5/02; H01R 13/627; H01R 24/20

(52) U.S. Cl. CPC H01R 35/04; B25F 5/02; H01R 13/6276; H01R 24/20

(57) ABSTRACT

A power tool includes a main housing including an electrical power source and a tool device having at least one electrical component. A flexible tool connection is connected between the main housing and the tool device. The flexible tool connection includes at least one electrical wire configured to electrically connect the electrical power source and the at least one electrical component. A rotatable electrical connector is between the main housing and the flexible tool connection. The rotatable electrical connector is configured to decouple torque applied to the tool device or the flexible tool connection from the main housing.

### CROSS-REFERENCE TO RELATED APPLICATIONS

The present application claims priority to Application No. PCT/EP2023/084389 filed on Dec. 5, 2023, which is herein incorporated by reference in its entirety.

### BACKGROUND OF THE INVENTION

### Field of the Invention

The present disclosure relates to a power tool and an electrical connector.

### Description of the Related Art

When pouring wet concrete on a worksite it is important to ensure that there are no air bubbles within the wet concrete before the concrete sets. Air bubbles can cause blisters or voids in the cured concrete surface which can weaken the concrete workpiece.

One known solution is to use a concrete vibration tool which releases trapped air bubbles from the wet concrete. An example of a concrete vibration tool is shown in DE 10 2016 105 983, wherein a vibrator device is placed into the wet concrete. The vibrator device comprises an electric motor and is connected to an electric supply line via a protective hose.

A problem with this arrangement is that the hose can restrict how the user can move the vibrator device in the wet concrete. The hose can also become twisted which can cause the electrical connection to be damaged.

### SUMMARY OF THE INVENTION

Examples of the present disclosure aim to address the aforementioned problems and other problems relating to handling and use of power tools with electrical connectors.

According to an aspect of the present disclosure there is a power tool comprising: a main housing comprising an electrical power source; a tool device comprising at least one electrical component; a flexible tool connection connected between the main housing and the tool device, the flexible tool connection comprising at least one electrical wire configured to electrically connect the electrical power source and the at least one electrical component; and a rotatable electrical connector between the main housing and the flexible tool connection, wherein the rotatable electrical connector is configured to decouple torque applied to the tool device or the flexible tool connection from the main housing.

Optionally, the flexible tool connection is a hose, a cable, or a tube.

Optionally, the rotatable electrical connector comprises a first connector element rotatably mounted on the main housing and a second connector element coupled to the flexible tool connection.

Optionally, the first connector element is a socket and the second connector element is a plug.

Optionally, the first connector element and the second connector element are configured to connect together in a plurality of different connection orientations.

Optionally, the second connector element comprises an alignment pin for engaging with at least one reciprocal alignment channel in the first connector element.

Optionally, the first connector element comprises a plurality of different reciprocal alignment channels and each alignment channel corresponds to a different connection orientation of the first and second connector elements.

Optionally, the rotatable electrical connector comprises a locking mechanism moveable between a locking position and a release position for selectively securing the first and second connector elements.

Optionally, the locking mechanism comprises a rotatable locking ring mounted on the first connector element moveable between the locking position and the release position.

Optionally, the rotatable locking ring comprises at least one locking ball and the second connector element comprises an annular recess configured to engage the at least one locking ball and the rotatable locking ring prevents the locking ball moving out of the annular recess when in the locking position.

Optionally, the rotatable locking ring is biased to the locking position.

Optionally, at least one rotatable bushing is rotatably mounted between the first connector element and the main housing.

Optionally, the at least one rotatable bushing comprises a plurality of rotatable bushings mounted between the first connector element and the main housing.

Optionally, the at least one rotatable bushing is configured to limit relative rotation of the first connector element with respect to the main housing.

Optionally, the at least one rotatable bushing comprises at least one first rotation stop configured to engage a connector stop fixed with respect to the first connector element and at least one second rotation stop configured to engage a sleeve stop fixed with respect to the main housing.

Optionally, the at least one first rotation stop is configured to engage the connector stop and the at least one second rotation stop is configured to engage the sleeve stop in a first rotational position and the at least one first rotation stop is configured to engage the connector stop and the at least one second rotation stop configured to engage the sleeve stop in a second rotational position.

Optionally, the first connector element is rotatable with respect to the main housing up to 720 degrees about a rotational axis when moving between the first rotational position and the second rotational position.

Optionally, the rotatable electrical connector comprises a rotation biasing mechanism configured to urge the rotatable first connector element to a home position when rotated to a rotated position away from the home position.

Optionally, the rotation biasing mechanism is mounted between the first connector element and the main housing and comprises at least one spring configured to urge the rotatable first connector element to the home position when the first connector element is rotated in first and second rotational directions.

Optionally, the at least one spring is a first spring and a second spring mounted on opposite sides of the first connector element.

Optionally, the at least one spring is a roller spring, a spiral spring, and/or a textile band.

Optionally, the power tool is a concrete vibrator.

Optionally, the at least one electrical component is a motor.

Optionally, the main housing is mountable on a backpack or on a floor surface.

Optionally, the rotatable electrical connector has a first rotation axis which is inclined with respect to a main housing longitudinal axis.

Optionally, the angle of inclination between the main housing longitudinal axis and the first rotation axis is between 5 degrees to 30 degrees.

Optionally, the first rotation axis is coaxial with a connector longitudinal axis.

Optionally, the locking mechanism comprises a camming surface configured to engage the flexible tool connection and to urge the flexible tool connection away from the rotatable electrical connector when the locking mechanism moves from the locking position to the release position.

Optionally, the rotatable locking ring comprises the camming surface.

Optionally, the camming surface is configured to engage a projecting finger mounted on the second connector element on the flexible tool connection.

Optionally, the rotatable electrical connector between the main housing and the flexible tool connection comprises a first rotation axis and a connector pivot axis.

Optionally, the first rotation axis is perpendicular to the connector pivot axis.

Optionally, the connector pivot axis is perpendicular to a longitudinal axis of the flexible tool connection when connected to the rotatable electrical connector.

Optionally, the first rotation axis is rotatable about the connector pivot axis between a range of −90 degrees and +90 degrees.

Optionally, the main housing comprises a yoke configured to rotatably mount the rotatable electrical connector about the connector pivot axis.

Optionally, the yoke comprises a first arm and a second arm configured to rotatably mount the rotatable electrical connector therebetween.

According to another aspect of the disclosure, there is provided a rotatable electrical connector for a power tool having a main housing comprising an electrical power source and a tool device comprising at least one electrical component and a flexible tool connection connected between the main housing and the tool device, the flexible tool connection comprising at least one electrical wire configured to electrically connect the electrical power source and the electrical component, the rotatable electrical connector comprising: a first connector element in electrical connection with the electrical power source in the main housing and rotatably mounted on the main housing; and a second connector element in electrical connection with the at least one electrical component in the tool device remote from the main housing; wherein the first and second connector elements are configured to electrically connect together and rotate together with respect to the main housing when connected such that torque applied to the tool device or the flexible tool connection is decoupled from the main housing.

According to another aspect of the disclosure, there is provided a rotatable electrical connector comprising: a first connector element in electrical connection with an electrical power source or a first electrical component coupled to a housing, the first connector element being rotatably mounted on the housing; a second connector element in electrical connection with a second electrical component remote from the housing, wherein the first and second connector elements are configured to electrically connect together and rotate together with respect to the housing when connected such that torque applied to the second connector element is at least partially decoupled from the housing; and a rotation biasing mechanism configured to urge the rotatable first connector element to a home position when rotated to a rotated position away from the home position.

According to another aspect of the disclosure, there is provided a power unit for a power tool having a tool device comprising at least one electrical component and a flexible tool connection comprising at least one electrical wire configured to electrically connect the power unit and the at least one electrical component, the power unit comprising: a main housing configured to receive an electrical power source; and a rotatable electrical connector mounted to the main housing and configured to decouple torque applied to the tool device or the flexible tool connection from the main housing when the flexible tool connection is connected to the rotatable electrical connector.

According to another aspect of the disclosure, there is a power unit for a power tool having a tool device comprising at least one electrical component and a flexible tool connection comprising at least one electrical wire configured to electrically connect the power unit and the at least one electrical component, the power unit comprising: a main housing having a main housing longitudinal axis, the main housing being configured to receive an electrical power source; and an electrical connector configured to connect the main housing to the flexible tool connection, wherein the electrical connector has a connector longitudinal axis which is inclined with respect to the main housing longitudinal axis.

Optionally, the angle of inclination between the main housing longitudinal axis and the connector longitudinal axis is between 5 degrees to 30 degrees.

Optionally, the main housing is mountable on a backpack or on a floor surface.

Optionally, the electrical connector is mounted to the main housing.

Optionally, the electrical connector is rotatable about the connector longitudinal axis

According to another aspect of the disclosure there is a power unit for a power tool having a tool device comprising at least one electrical component and a flexible tool connection comprising at least one electrical wire configured to electrically connect the power unit and the at least one electrical component, the power unit comprising: a main housing configured to receive an electrical power source; and an electrical connector configured to connect the main housing to the flexible tool connection; wherein the power tool comprises a locking mechanism moveable between a locked position in which the flexible tool connection is secured to the main housing and a release position in which the flexible tool connection is releasable from the main housing, wherein the locking mechanism comprises a camming surface configured to engage the flexible tool connection and to urge the flexible tool connection away from the electrical connector when the locking mechanism moves from the locking position to the release position.

Optionally, the locking mechanism comprises a rotatable locking ring comprising the camming surface and the rotatable locking ring is rotatable between the locked position and the release position.

Optionally, the camming surface is configured to engage a projecting finger mounted on the second connector element of the flexible tool connection.

Optionally, the electrical connector is rotatable about a connector longitudinal axis

According to another aspect of the disclosure there is provided a power unit for a power tool having a tool device comprising at least one electrical component and a flexible tool connection comprising at least one electrical wire configured to electrically connect the power unit and the at least one electrical component, the power unit comprising: a main housing having a main housing longitudinal axis, the main housing being configured to receive an electrical power source; and an electrical connector configured to connect the main housing to the flexible tool connection; wherein the electrical connector comprises a connector longitudinal axis and the electrical connector is pivotable about a connector pivot axis in which connector longitudinal axis forms a first angle with respect to the main housing longitudinal axis and a second position in which the connector longitudinal axis forms a second, different, angle with respect to the main housing longitudinal axis.

Optionally, the connector longitudinal axis is perpendicular to the connector pivot axis.

Optionally, the connector longitudinal axis is pivotable about the connector pivot axis between a range of −90 degrees and +90 degrees.

Optionally, the main housing comprises a yoke configured to rotatably mount the electrical connector about the connector pivot axis.

Optionally, the yoke comprises a first arm and a second arm configured to rotatably mount the electrical connector therebetween.

Optionally, the electrical connector is pivotable about multiple connector pivot axes.

Optionally, the electrical connector is mounted to the main housing via a ball and socket joint or a swivel joint.

Optionally, the electrical connector is rotatable about the connector longitudinal axis.

According to another aspect of the disclosure there is provided a power tool comprising: a power unit according to at least one of the previous aspects; an electrical power source received in the main housing; a tool device comprising at least one electrical component; and a flexible tool connection connected between the main housing and the tool device, the flexible tool connection comprising at least one electrical wire configured to electrically connect the electrical power source and the at least one electrical component.

### BRIEF DESCRIPTION OF THE DRAWINGS

Various other aspects and further examples are also described in the following detailed description and in the attached claims with reference to the accompanying drawings, in which:

FIGS. 1A and 1B show a power tool according to examples;

FIG. 2 shows a close-up perspective view of a power tool according to an example;

FIG. 3 shows an exploded perspective view of a rotatable electrical connector according to an example;

FIG. 4 shows a perspective view of part of a rotatable electrical connector according to an example;

FIGS. 5 and 6 show side cross-sectional views of a rotatable electrical connector according to an example;

FIG. 7 shows another exploded perspective view of part of a rotatable electrical connector according to an example;

FIGS. 8A and 8B show schematic end on views of the rotatable electrical connector in different rotational positions according to an example;

FIG. 9 shows a perspective view of part of a rotatable electrical connector according to an example;

FIG. 10 shows a perspective view of part of a rotatable electrical connector according to an example;

FIG. 11 shows a perspective view of part of a rotatable electrical connector according to an example;

FIG. 12 shows a side view of a power tool according to another example;

FIGS. 13A to 13C show an electrical connector in different positions according to another example;

FIGS. 14A and 14B show a side view of a power tool according to another example;

FIGS. 15A and 15B show a partial close-up side cross-sectional view of a power tool according to another example.

### DETAILED DESCRIPTION OF INVENTION

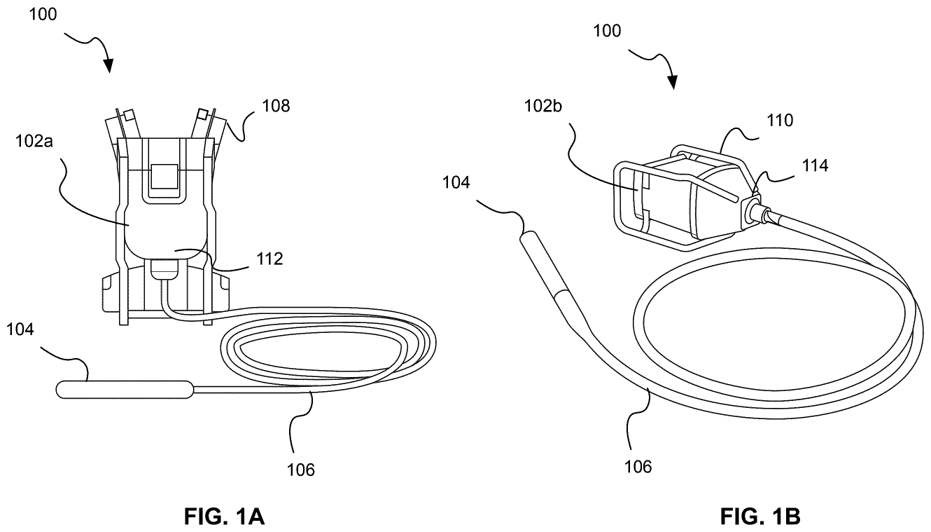

FIGS. 1A and 1B show a power tool 100. Specifically, the power tool 100 as shown in FIGS. 1B and 1B is a concrete vibrator 100. The concrete vibrator 100 comprises a power unit having a main housing 102a, 102b and a tool device 104. FIG. 1A shows the main housing 102a connected to a harness 108 for mounting on a user's back. Providing a harness 108 for a power tool 100 is known and will not be discussed in any further detail. Conversely, FIG. 1B shows an alternative arrangement of the power tool 100, wherein the main housing 102b comprises a floor mounted frame 110 configured to rest on a floor surface 1202.

The power unit provides electrical power to the tool device 104 via an electrical hose 106 connectable to the main housing 102a, 102b. The power unit is connectable to a power source such as a rechargeable battery pack which can be removably mounted to an interface on the main housing. The main housing may comprise an inverter for converting DC power from the power source to AC power to provide to a motor of the tool device 104. Additionally or alternatively, the main housing may comprise a DC to DC converter to convert the voltage from the power source to a voltage suitable for the tool device. The main housing may comprise a controller for controlling to power suppled from the power source to the tool device.

The power unit can comprise any suitable form for housing components of the power unit. As mentioned, the main housing 102a is a back mounted harness 108 or the main housing 102b is a floor mounted frame 110. In other examples, the main housing 102 can be any suitable shape or size and mountable on any suitable surface. For example, the main housing 102 can be mountable on a vehicle e.g. a floor of a truck or mountable on a wall or other vertical surface. For the purposes of conciseness, hereinafter the main housing 102a, 102b as shown in FIGS. 1A and 1B will be generally referred to using the reference number 102 (unless otherwise specified) to indicate the main housing 102 of the power unit irrespective of the type or form of the power tool 100.

The tool device 104 is connected to the main housing 102 via the electrical hose 106. The electrical hose 106 comprises at least one electrical wire and electrically connects a power source (not shown) mounted in the main housing 102 with at least one electrical component in the tool device 104. The electrical hose 106 is durable and flexible. This means that the tool device 104 can be used remotely from the main housing 102 whilst still being powered from the power source mounted in the main housing 102. The electrical hose 106 in some examples comprises an outer sheath configured to protect the internal electrical wires from caustic or corrosive materials and other mechanical damage.

The power source mounted in the main housing 102 can be any suitable power source configured to provide electrical power to the tool device 104. For example, the power source can be one or more battery packs. Additionally or alternatively the power source can be a mains power source.

In some examples, the tool device 104 is a vibrating tool which comprises a motor (not shown) and is configured to drive an oscillating mass (not shown) to cause the tool device 104 to vibrate. The use of a motor operatively connected to an oscillating mass to vibrate the tool device 104 is known and will not be discussed in any further detail.

In use, the user inserts the tool device 104 into a wet concrete mix that has been poured at a worksite. The user grips electrical hose 106 with one or both hands as required. As the tool device 104 vibrates, the air bubbles in the wet concrete mix rise up in the wet cement mix and are expelled. The tool device 104 is connected via the electrical hose 106 and is remote from the main housing 102 and therefore the main housing 102 does not interfere with the user's operation of the tool device 104. For example, mounting the power source in the main housing 102 means that the tool device 104 is lighter and easier to manipulate.

Whilst FIGS. 1A and 1B show different examples of a concrete vibrator 100, in other examples other the features discussed herein can be applied to any suitable power tool 100 with a power unit having a main housing 102 connected to a tool device 104 via a flexible tool connection 106. In some examples, the flexible tool connection 106 is a hose, a cable, or a tube having an electrical wire or any other suitable flexible connection between the main housing 102 and the tool device 104. In some examples e.g. as shown in the Figures, the flexible tool connection 106 is an electrical hose 106. The term electrical hose 106 will be used hereinafter when describing the examples shown in the Figures, but any of the examples described can be used with other flexible tool connections.

For example, the tool device 104 can be an inspection light (not shown). Alternatively, the tool device 104 can be a leaf blower or a vacuum cleaner with an integrated motor fan assembly configured to generate an air flow. In some other examples, the tool device 104 can be any electrically powered tool such as a string trimmer, a hedge trimmer, a chain saw, grass shears, an angle grinder, a hammer drill, a reciprocating saw, a demolition hammer, a rammer, a plate compactor etc. If the main housing 102 comprises a plurality of battery packs, the tool device 104 can be a battery powered power tool 100 and be connected to the electrical hose 106. This means that the tool device 104 will still be portable whilst having an extended run time.

Hereinafter, the term power tool 100 will be used to describe the concrete vibrator 100 or any other suitable power tool 100 with a main housing 102 connected to a tool device 104 via the electrical hose 106.

As the user moves and manipulates the tool device 104, the electrical hose 106 can be twisted about the longitudinal axis of the electrical hose 106. One problem with previously known tools e.g. the concrete vibrator as disclosed in DE 10 2016 105 983 is that the torque from the electrical hose 106 is transferred to the main housing 102. This means that for example when the main housing 102b comprises a floor mounted frame 110, the main housing 102b may roll around the floor surface 1202 due to the torque exerted on the electrical hose 106. Alternatively, for example when the main housing 102a comprises a back mounted harness 108, the twisting of the electrical hose 106 can severely limit the user moving the tool device 104 and the electric hose 106. This can mean that the electrical hose 106 may be damaged at the connection with the main housing 102.

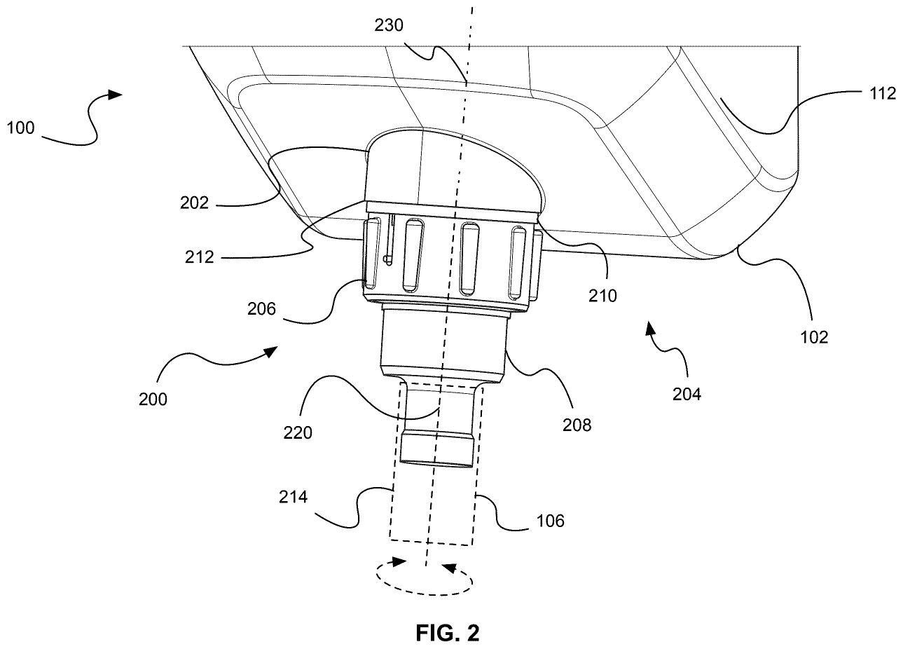

In order to mitigate this problem, the power tool 100 comprises a rotatable electrical connector 200 between the power unit main housing 102 and the electrical hose 106 as shown in FIG. 2. FIG. 2 shows a close-up perspective view of the power unit main housing and the rotatable electrical connector 200. An end 214 of the electrical hose 106 near the main housing 102 in FIG. 2 has been represented in a dotted outline for the purposes of clarity. Accordingly, the rotatable electrical connector 200 is configured to decouple torque applied to the tool device 104 or the electrical hose 106 from the main housing 102. This means that the user can twist the tool device 104 and/or the electrical hose 106 and the main housing 102 is not affected. This protects the main housing 102 and the wires from the torque applied at the tool device 104.

The rotatable electrical connector 200 comprises a first connector element 206 rotatably mounted on the main housing 102 and a second connector element 208 coupled to the electrical hose 106. The first connector element 206 and the second connector element 208 are configured to electrically connect together. In some examples, the first connector element 206 is detachably connectable to the second connector element 208. This means that the electrical hose 106 can be detached from the main housing 102. As required, the user can attach and detach the electrical hose 106 from the main housing 102 by disconnecting the first connector element 206 from the second connector element 208.

When the first connector element 206 and the second connector element 208 are electrically connected together, the power source in the main housing 102 and the electrical component in the tool device 104 are electrically connected. In some examples, the first and second connector elements 206, 208 are configured to mechanically connect together in addition to electrically connect together.

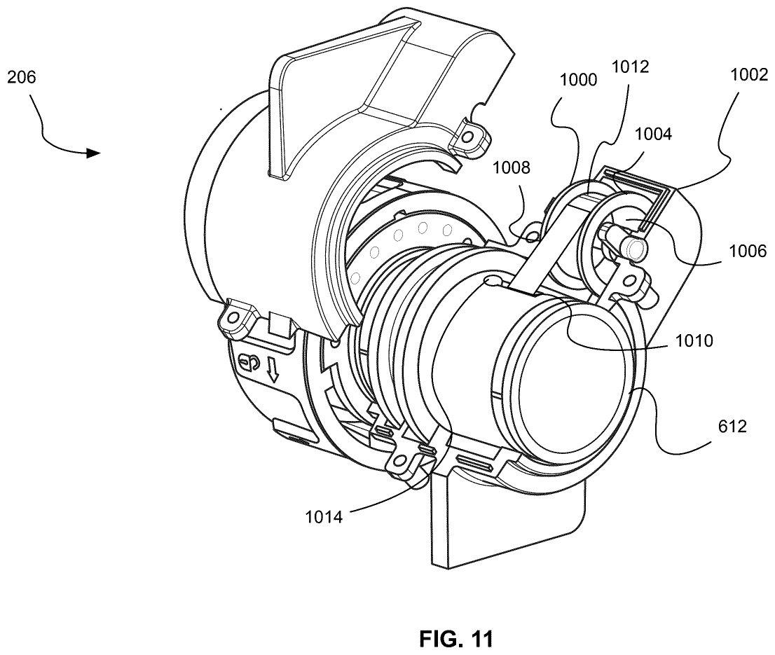

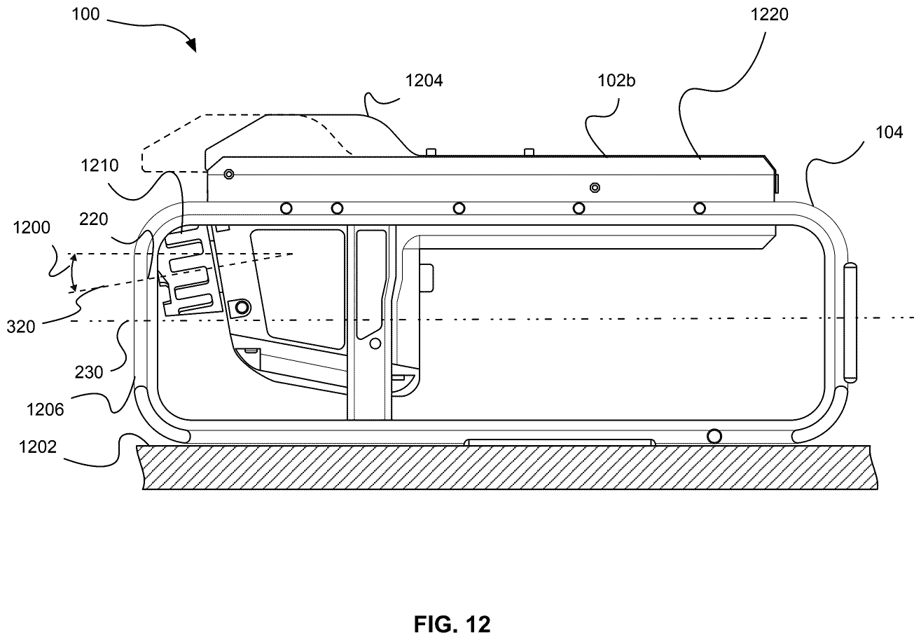

The rotatable electrical connector 200 is rotatable about a first rotation axis 220 with respect to the main housing 102 as indicated by the double ended dotted arrow in FIG. 2. When the first and second connector elements 206, 208 are connected together, they are fixed with respect to each other and both the first and second connector elements 206, 208 are configured to rotate together in unison about the first rotational axis 220 with respect to the main housing 102. In some examples, the first rotational axis 220 of the rotatable electrical connector 200 is parallel to a main housing longitudinal axis 230. As shown in FIG. 2, the first rotational axis 220 is optionally coaxial with the main housing longitudinal axis 230. Optionally, in other examples the first rotational axis 220 of the rotatable electrical connector 200 is inclined with respect to the main housing longitudinal axis 230 e.g. as shown in FIG. 12 described below in more detail.

The rotatable electrical connector 200 is rotatably mounted to a housing connector portion 202 integral with the main housing 102. The housing connector portion 202 as shown in FIG. 2 is a projecting portion of the main housing 102. The housing connector portion 202 provides a hole in the main housing 102 for receiving at least a portion of the rotatable electrical connector 200. At least a portion of the rotatable electrical connector 200 projects into the housing connector portion 202 and rotates with respect to the housing connector portion 202. However, the housing connector portion 202 is optional and in some other examples, the main housing 102 just comprises a hole for receiving the rotatable electrical connector 200.

The first connector element 206 and the second connector element 208 are generally cylindrical in shape and aligned along the first rotational axis 220. The first connector element 206 and the second connector element 208 are hollow and at least one wire (not shown) is received within the first connector element 206 and the second connector element 208. In some examples, there are a plurality of wires e.g. three wires corresponding to three phases electrically connected to an AC power source. The wires connected to the first connector element 206 are routed into the main housing 102 via the housing connector portion 202. In some other examples, there can be any suitable number of wires electrically connected together by the first connector element 206 and the second connector element 208. Furthermore, one or more of the wires can provide data connectivity between the main housing 102 and the tool device 104 in addition or alternatively to electrical power.

As shown in FIG. 2, the housing connector portion 202 is moulded in an end 204 of the main housing 102. The housing connector portion 202 is shown in FIGS. 1A and 1B, wherein the housing connector portion 202 is respectively mounted on a lower end 112 of the main housing 102a of the back mounted harness 108 and a front side 114 of the floor mounted frame 110.

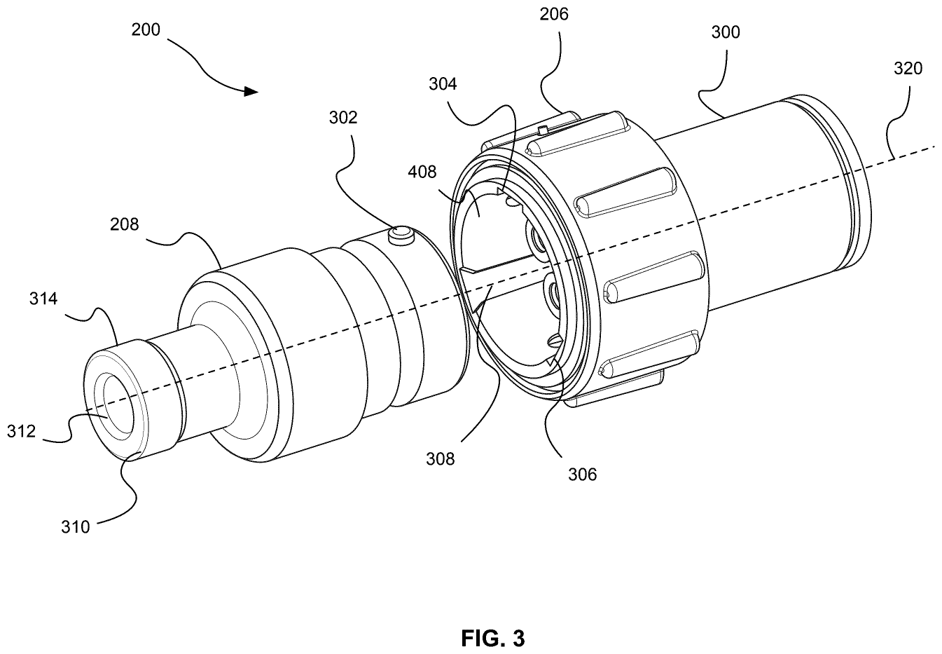

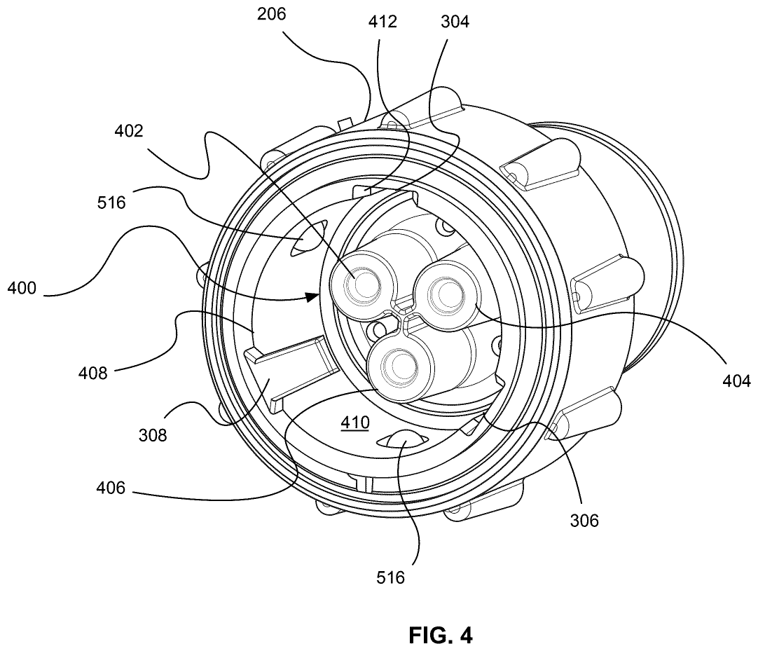

FIG. 3 shows an exploded perspective view of the first connector element 206 and the second connector element 208 of the rotatable electrical connector 200. As shown in FIG. 3, the first connector element 206 is a socket and the second connector element 208 is a plug electrically connectable to the socket. The first connector element 206 is also shown in FIG. 4. FIG. 4 shows another perspective view of the first connector element 206.

The rotatable electrical connector 200 comprises a connector longitudinal axis 320 as shown in FIGS. 3, 5 and 6. The first connector element 206 and the second connector element 208 extend along the connector longitudinal axis 320. In some examples, the connector longitudinal axis 320 is coaxial with the first rotational axis 220. In other examples, the connector longitudinal axis 320 is parallel but e.g. offset from the first rotational axis 220. Accordingly in some examples the connector longitudinal axis 320 is also coaxial with the main housing longitudinal axis 230. Optionally, in other examples the connector longitudinal axis 320 of the rotatable electrical connector 200 is inclined with respect to the main housing longitudinal axis 230 e.g. as shown in FIG. 12 described below in more detail.

In some examples, the first connector element 206 is inserted into an optional connector sleeve 300 configured to be mounted in the housing connector portion 202. The connector sleeve 300 is fixed with respect to the housing connector portion 202 and the first connector element 206 is rotatable about the first rotation axis 220 within the connector sleeve 300. The connector sleeve 300 comprises a flange 210 which engages a lip 212 of the housing connector portion 202. This ensures that the connector sleeve 300 is correctly seated within the housing connector portion 202 and the first and second connector elements 206, 208 rotate about the first rotation axis 220. In some examples, the connector sleeve 300 is not a separate component and integral with the housing connector portion 202.

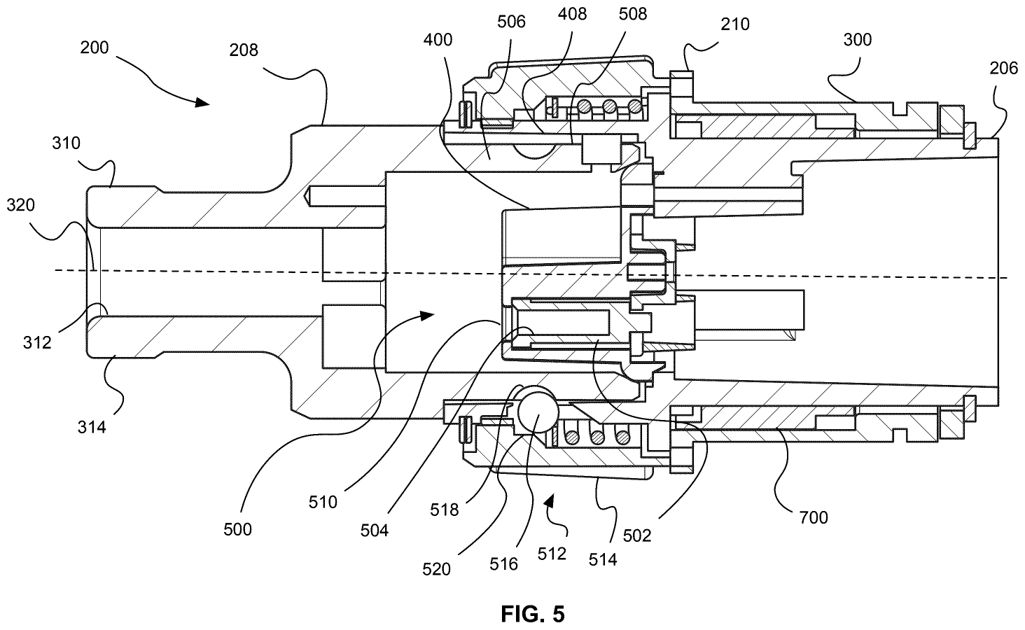

As shown in FIG. 4, the first connector element 206 comprises a projecting central socket portion 400 configured to receive a reciprocal plug portion 500 of the second connector element 208. The central socket portion 400 projects into a socket cavity 410 defined by the inner wall 408 of the first connector element 206. The projecting central socket portion 400 comprises a first phase socket connector 402, a second phase socket connector 404, and a third phase socket connector 406. Each of the first phase socket connector 402, the second phase socket connector 404, and the third phase socket connector 406 comprises a hole with a metal connector clip 502 mounted therein. The metal connector clips 502 are each connected to a respective wire in electrical connection with the power source in the main housing 102. The metal connector clip 502 of the first phase socket connector 402 is shown in FIG. 5. FIG. 5 shows a cross-sectional view of the rotatable electrical connector 200 with the first connector element 206 and the second connector element 208 electrically connected together.

The second connector element 208 is a plug and comprises a projecting plug body 506. The projecting plug body 506 is arranged to be inserted into the socket cavity 410 of the first connector element 206 such that an outer wall 508 of the projecting plug body 506 is adjacent to the inner wall 408 of the first connector element 206 in the socket cavity 410. The projecting plug body 506 comprises a reciprocal plug cavity 510 for receiving the projecting central socket portion 400.

FIG. 5 shows the metal connector clip 502 of the first phase socket connector 402 connected to a first phase plug pin 504. The first phase plug pin 504 is detachably connectable to the metal connector clip 502 of the first phase socket connector 402. Although not shown in FIG. 5, the reciprocal plug cavity 510 also comprises a second phase plug pin and a third phase plug pin in addition to the first phase plug pin 504.

The second phase plug pin and the third phase plug pin are the same as the first phase plug pin 504. The second phase plug pin and the third phase plug pin are similarly configured to respectively electrically connect to the metal connector clip of the second phase socket connector 404 and the metal connector clip of the third phase socket connector 406. The metal connector clips of the second phase socket connector 404 and the third phase socket connector 406 are the same as the metal connector clip 502 of the first phase socket connector 402, but are not shown in FIG. 5.

Turning back to FIG. 3, the second connector element 208 comprises a projecting alignment peg 302 for aligning the second connector element 208 with first connector element 206 when the first and second connector elements 206, 208 are pushed together. The projecting alignment peg 302 is configured to be received in a first alignment channel 304 located in the inner wall 408 of the first connector element 206. When the projecting alignment peg 302 slots into the first alignment channel 304, the reciprocal plug portion 500 of the second connector element 208 is aligned with the central socket portion 400 of the first connector element 206.

Furthermore, when the projecting alignment peg 302 fully slots into the first alignment channel 304, the metal connector clip 502 of the first phase socket connector 402 is connected to a first phase plug pin 504, the metal connector clip of the second phase socket connector 404 is connected to a second phase plug pin and the metal connector clip of the third phase socket connector 406 is connected to a third phase plug pin. The projecting alignment peg 302 slots into the first alignment channel 304 ensure that the first connector element 206 and the second connector element 208 easily fit together.

In some examples, there is only one first alignment channel 304 in the first connector element 206. This means that the projecting alignment peg 302 and the first alignment channel 304 provide a single orientation that the first and second connector elements 206, 208 can fit together. This may be required if the specific wires in the first and second connector elements 206, 208 must be matched and connected. For example, one of the wires is a data connection and should not receive a high voltage associated with a power source.

In some other examples, the tool device 104 does not require the three phase plug pins 504 to be connected together in a specific orientation e.g. each of the phase plug pins 504 do not need to be matched with a specific reciprocal metal connector clip 502. For example, the first phase plug pin 504 can connect together with either the metal connector clip 502 of the second phase socket connector 404 or the metal connector clip of the third phase socket connector 406. Similarly, the other phase plug pins can be connected with any of the other reciprocal metal connector clips.

The first connector element 206 further comprises a second alignment channel 306 and a third alignment channel 308. The second alignment channel 306 and the third alignment channel 308 are also located in the inner wall 408 of the first connector element 206. When the projecting alignment peg 302 slots into the second alignment channel 306 or the third alignment channel 308, the reciprocal plug portion 500 of the second connector element 208 is aligned with the central socket portion 400 of the first connector element 206.

Each of the first, second and third alignment channels 304, 306, 308 corresponds to a different connection orientation of the first connector element 206 with respect to the second connector element 208 when receiving the projecting alignment peg 302. The first, second and third alignment channels 304, 306, 308 are circumferentially spaced by 120 degrees.

In order to aid the alignment of the projecting alignment peg 302 in the first alignment channel 304, the mouth 412 of the first alignment channel 304 is wider than the width of the first alignment channel 304. The mouth 412 comprises chamfered walls which narrow from the larger width of the mouth 412 to the narrower width of the rest of the first alignment channel 304. The second and third alignment channels 306, 308 also comprise a similar channel structure.

Whilst the arrangement as shown in FIG. 3 shows the first and second connector elements 206, 208 having three different connection orientations, in other examples the first and second connector elements 206, 208 can have any number of different connection orientations provided by the first, second and third alignment channels 304, 306, 308.

As mentioned above, the first connector element 206 is a socket and the second connector element 208 is a plug. However, in some other examples, the first connector element 206 is a plug and the second connector element 208 is a socket.

The second connector element 208 comprises a hose sleeve portion 310 configured to engage with the electrical hose 106 as shown in FIG. 3. The hose sleeve portion 310 comprises an inner conduit 312 for receiving the wires (not shown). The hose sleeve portion 310 is configured to be inserted within the outer sheath of the electrical hose 106. The hose sleeve portion 310 also comprises a protruding lip 314 for preventing the electrical hose 106 slipping off the hose sleeve portion 310. The outer sheath of electrical hose 106 can be overmolded over the wires and the hose sleeve portion 310 of the second connector element 208. In some other examples, the outer sheath of the electrical hose 106 is a rubber or silicone sleeve and the wires are threaded therethrough. The outer sheath of the electrical hose 106 is then slid onto the hose sleeve portion 310. Additionally or alternatively, a clip (not shown) can be fastened around the outer sheath of the electrical hose 106 around the hose sleeve portion 310 when the electrical hose 106 is mounted to the second connector element 208. Other suitable solutions can alternatively or additionally be used to fix the hose sleeve portion 310 with respect to the electrical hose 106 e.g. adhesive.

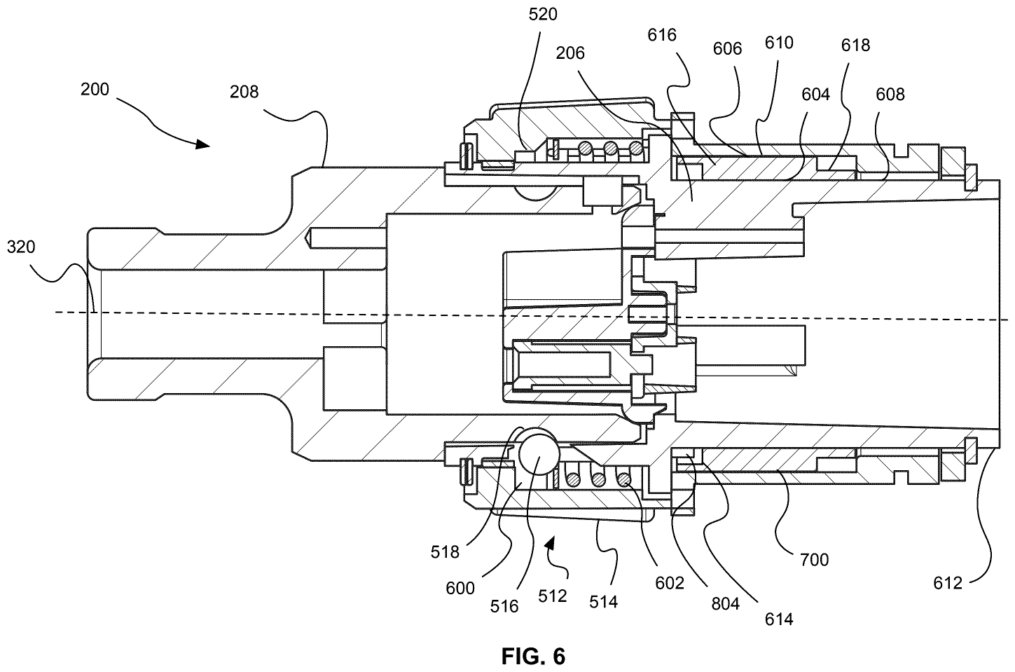

The rotatable electrical connector 200 may optionally comprise a locking mechanism 512. The locking mechanism 512 will be discussed in more detail with respect to FIGS. 5 and 6. FIGS. 5 and 6 show a cross-sectional side view of the rotatable electrical connector 200 with the locking mechanism 512 in different positions.

The locking mechanism 512 moveable between a locking position and a release position for selectively securing the first and second connector elements 206, 208 together. This means that when the locking mechanism 512 is in the locking position, the first and second connector elements 206, 208 cannot be disconnected and when the locking mechanism 512 is in the release position, the first and second connector elements 206, 208 are separable.

The locking mechanism 512 comprises a rotatable locking ring 514 mounted on the first connector element 206. The rotatable locking ring 514 is rotatable about the first rotation axis 220 of the rotatable electrical connector 200. The rotatable locking ring 514 is shown in the locking position in FIG. 5 and in the release position in FIG. 6.

The user rotates the rotatable locking ring 514 about the first rotation axis 220 with respect to the first connector element 206 to move the rotatable locking ring 514 from the locking position to the release position. In the locking position, the rotatable locking ring 514 urges a steel ball 516 into an annular groove 518 in the second connector element 208. When the steel ball 516 engages the annular groove 518, the second connector element 208 is prevented from moving with respect to the first connector element 206 in a direction along the first rotation axis 220.

The rotatable locking ring 514 comprises a locking ramp portion 520 which forces the steel ball 516 into the annular groove 518. The locking ramp portion 520 also prevents the steel ball 516 from moving in a direction perpendicular to the first rotation axis 220 out of the annular groove 518.

FIG. 6 shows the rotatable locking ring 514 having been rotated to the release position. In the release position, the locking ramp portion 520 has rotated with respect to the first connector element 206 and the steel ball 516. Accordingly, the locking ramp portion 520 no longer urges the steel ball 516 into the annular groove 518 in the second connector element 208. Instead, a void 600 is positioned next to the steel ball 516. This means that the steel ball 516 is no longer prevented from moving with respect to the first connector element 206 in a direction along the first rotation axis 220. Therefore, as the user pulls the second connector element 208 away from the first connector element 206, the steel ball 516 moves into the void 600 and moves Out of engagement with the annular groove 518.

In some examples, the rotatable locking ring 514 is biased to the locking position by a biasing spring 602 connected between the first connector element 206 and the rotatable locking ring 514. This means that in order to remove the second connector element 208 from the first connector element 206, the user must use two hands to first twist the rotatable locking ring 514 and then pull the first and second connector elements 206, 208 apart. This means that the user is less likely to accidentally separate the first connector element 206 from the second connector element 208.

In some examples, there are a plurality of steel balls 516 each configured to selectively engage the annular groove 518 in the second connector element 208. In some examples, there are three steel balls 516 circumferentially spaced at 120 degree angles. This ensures a better connection between the first and second connector elements 206, 208. In the example where the locking mechanism 512 comprises three steel balls 516, the rotatable locking ring 514 comprises three locking ramp portions 520 each configured to urge the respective steel ball 516 into the annular groove 518 in the locking position.

As mentioned above, the locking mechanism 512 is optional. In some other examples, there is no locking mechanism 512 and the first connector element 206 and the second connector element 208 are held together by friction alone. In some other examples, the locking mechanism 512 can comprise any other suitable mechanism for holding the first and second connector elements 206, 208 together such as a resilient clip mounted on the first connector element 206 which provides a snap-fit engagement with a reciprocal recess on the second connector element 208.

One problem with rotating the electrical hose 106 with respect to the main housing 102 is that the electrical wires can suffer damage and break if the relative rotation between the electrical hose 106 and the main housing 102a is excessive. One option is to limit the relative rotation of the electrical hose 106 with respect to the main housing 102. This means that the electrical hose 106 can rotate with respect to the main housing 102, but not damage the internal wires. The electrical wires within the rotatable electrical connector 200 and the main housing 102 have some slack in order to permit some internal movement thereof when the rotatable electrical connector 200 rotates.

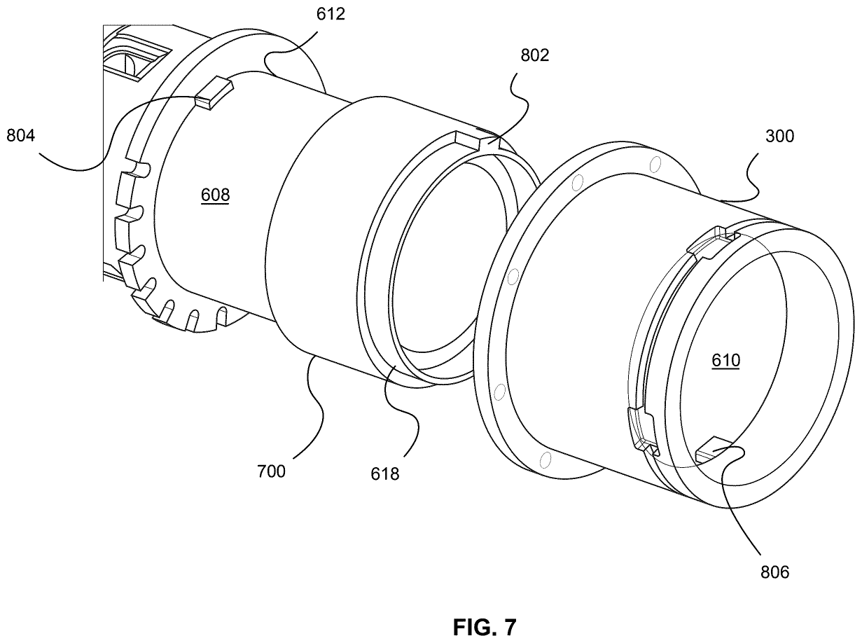

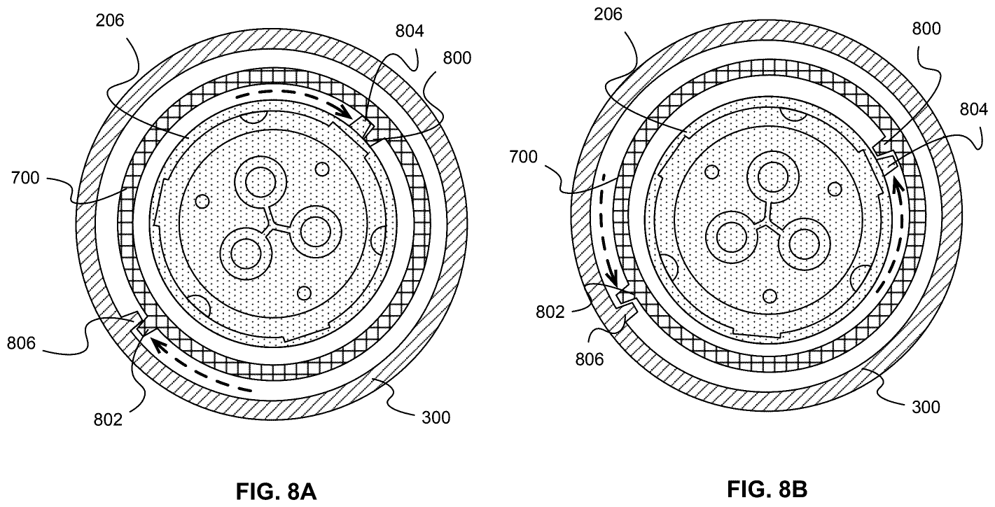

The limitation of the rotational movement of the rotatable electrical connector 200 will now be discussed in reference to FIGS. 7, 8A and 8B. FIG. 7 shows an exploded perspective view of the rotatable electrical connector 200. FIGS. 8A and 8B show schematic end-on cross sectional views of the rotatable electrical connector 200.

FIG. 7 shows a rotatable bushing 700 mounted between the first connector element 206 and the connector sleeve 300. The rotatable bushing 700 is cylindrical in construction and coaxial with both the first rotational axis 220 and the connector longitudinal axis 320. The rotatable bushing 700 is configured to rotate about the first rotation axis 220, similar to the first connector element 206. The rotatable bushing 700 is rotatable about the first rotation axis 220 with respect to the first connector element 206 and the connector sleeve 300 and main housing 102. As mentioned above, if the optional connector sleeve 300 is omitted, then the rotatable bushing 700 is rotatable about the first rotation axis 220 with respect to the first connector element 206 and the main housing 102.

The rotatable bushing 700 is rotatably mounted on a central tube portion 612 of the first connector element 206. The central tube portion 612 of the first connector element 206 is configured to protrude into the main housing 102 through the housing connector portion 202. The rotatable bushing 700 comprises a first rotating surface 604 in rotating engagement with an outer surface 608 of the central tube portion 612 of the first connector element 206.

The rotatable bushing 700 is rotatably mounted within the connector sleeve 300. Both the rotatable bushing 700 and the central tube portion 612 of the first connector element 206 are inserted into the connector sleeve 300. The rotatable bushing 700 is concentric with the connector sleeve 300 and the central tube portion 612 of the first connector element 206 is concentric with the rotatable bushing 700 and the connector sleeve 300. The rotatable bushing 700 also comprises a second rotating surface 606 in rotating engagement with an inner surface 610 of the connector sleeve 300.

Accordingly, when the first connector element 206 rotates with respect to the main housing 102, the first connector element 206 can rotate with respect to the rotatable bushing 700 as well. However, the first connector element 206 can also rotate with respect to the main housing 102 and the rotatable bushing 700.

The rotatable bushing 700 limits the relative rotation of the first connector element 206 with respect to the main housing 102. When the rotatable bushing 700 is mounted between the first connector element 206 and the connector sleeve 300, the first connector element 206 is rotatable with respect to the connector sleeve 300 by up to 720 degrees.

Accordingly, the rotatable bushing 700 permits the relative rotation of first connector element 206 with respect to the connector sleeve 300 from a first rotational position as shown in FIG. 8A to a second rotational position as shown in FIG. 8B. The rotatable bushing 700 comprises a first rotational stop 800 configured to limit the relative rotation of the first connector element 206 with respect to the rotatable bushing 700. The rotatable bushing 700 also comprises a second rotational stop 802 configured to limit the relative rotation of the rotatable bushing 700 with respect to the connector sleeve 300.

The first rotational stop 800 on the rotatable bushing 700 is configured to engage a connector stop 804 in the first rotational position and the second rotational position. The connector stop 804 is fixed with respect to the first connector element 206. Accordingly, the connector stop 804 rotates together with the first connector element 206. The connector stop 804 is mounted on the outer surface 608 of the central tube portion 612 of the first connector element 206. The connector stop 804 projects radially outward from the outer surface 608 of the central tube portion 612 of the first connector element 206 towards the rotatable bushing 700.

The rotatable bushing 700 comprises a connector stop channel 614. The connector stop channel 614 is located in the bushing wall 616 of the rotatable bushing 700. The connector stop channel 614 extends circumferentially around most of the bushing wall 616 of the rotatable bushing 700. The connector stop channel 614 in the rotatable bushing 700 allows the connector stop 804 to move freely with respect to the rotatable bushing 700 without projecting beyond the second rotating surface 606. This means that the connector stop 804 does not interfere with the connector sleeve 300. The first rotational stop 800 is mounted in the connector stop channel 614 and blocks the path of the connector stop 804.

In FIG. 8A the connector stop 804 engages a first side of the first rotational stop 800 in the first rotational position. In FIG. 8B, the connector stop 804 engages a second side of the first rotational stop 800 in the second rotational position. Accordingly, the first rotational stop 800 permits the connector stop 804 and the first connector element 206 to rotate relative thereto by just under 360 degrees of rotation. The angular width of the first rotational stop 800 means that connector stop 804 and the first connector element 206 are limited below 360 degrees of rotation with respect to the rotatable bushing 700.

The second rotational stop 802 on the rotatable bushing 700 is configured to engage a sleeve stop 806 in the first rotational position and the second rotational position. The sleeve stop 806 is fixed with respect to the connector sleeve 300 and the main housing 102. The sleeve stop 806 does not rotate about the first rotation axis 220.

The sleeve stop 806 is mounted on the inner surface 610 of the connector sleeve 300. The sleeve stop 806 projects radially inward from the inner surface 610 of the connector sleeve 300 towards the rotatable bushing 700.

The rotatable bushing 700 comprises a sleeve stop channel 618. The sleeve stop channel 618 is located in the bushing wall 616 of the rotatable bushing 700. The sleeve stop channel 618 extends circumferentially around most of the bushing wall 616 of the rotatable bushing 700. The sleeve stop channel 618 in the rotatable bushing 700 allows the rotatable bushing 700 to move with respect to the sleeve stop 806. This means that the sleeve stop 806 does not interfere with the first connector element 206. The second rotational stop 802 is mounted in the sleeve stop channel 618 and blocks the path of the sleeve stop 806.

In FIG. 8A, the sleeve stop 806 engages a first side of the second rotational stop 802 in the first rotational position. In FIG. 8B, the sleeve stop 806 engages a second side of the second rotational stop 802 in the second rotational position. Accordingly, the second rotational stop 802 and the sleeve stop 806 permit the rotatable bushing 700 to rotate with respect to the connector sleeve 300 by just under 360 degrees of rotation. The angular width of the second rotational stop 802 means that rotatable bushing 700 is limited below 360 degrees of rotation with respect to the connector sleeve 300.

As mentioned above, the connector sleeve 300 can be optional or e.g. integral with the main housing 102. In this case, the sleeve stop 806 is integral with the main housing 102. Nevertheless, the sleeve stop 806 provides the same functionality of limiting the relative rotation of the rotatable bushing 700 whether mounted on the connector sleeve 300 or mounted on the main housing 102.

As shown in FIGS. 8A and 8B, the first and second rotational stops 800, 802 limit the rotation of the connector stop 804 and the sleeve stop 806 between both the first rotational position and the second rotational position. If the relative rotation is required to be significantly less than 360 degrees, then the angular width of the first and second rotational stops 800, 802 can be increased. Alternatively, in some other examples, there can be two first rotational stops 800 (not shown) and two second rotational stops 802 to provide the rotational stop position in the first rotational position and the second rotational position. This means that the relative rotation between the first connector element 206 and the rotatable bushing 700 and the rotatable bushing 700 and the connector sleeve 300 can be a half turn or a quarter turn e.g. 180 degrees, 90 degrees etc.

FIGS. 5, 6, and 7 all show a single rotatable bushing 700 mounted between the first connector element 206 and the connector sleeve 300. In some other examples, there can be two rotatable bushings 700 mounted between the first connector element 206 and the connector sleeve 300. The two rotatable bushings 700 comprise the same functionality as described in reference to the Figures. The connector stop channel 614 of one rotatable bushing 700 is rotatably engageable with the sleeve stop channel 618 of the other rotatable bushing 700. Accordingly, the first rotational stop 800 of one rotatable bushing 700 is configured to limit rotational movement of the second rotational stop 802.

This means that when there are two rotatable bushings 700, the two rotatable bushing 700 can rotate relative to each other e.g. just under 360 degrees of relative rotation. This means that the first connector element 206 is able to rotate up to 1080 degrees of relative rotation about the first rotation axis 220 with respect to the connector sleeve 300.

In some further examples, any number of rotatable bushings 700 e.g. 3, 4, 5, 6 etc can be mounted between the first connector element 206 and the connector sleeve 300. Adding additional rotatable bushings 700 will extend the length of the overall rotatable electrical connector 200.

In another example, the rotatable bushing 700 is optional. In this example, there is no rotatable bushing 700 and rotational movement of the first connector element 206 with respect to the connector sleeve 300 is not limited. In this case, the electrical wires are connected to an electrical slip ring component (not shown) in the connector sleeve 300. This means that the wires can maintain electrical connection with the power source in the main housing 102 independent of the rotational position of the first connector element 206 with respect to the connector sleeve 300. However, it may be less preferable to provide an electrical slip ring component because this introduces an additional possible point of failure into the rotatable electrical connector 200.

A problem with permitting relative movement between the electrical hose 106 and the main housing 102 is that the first connector element 206 can move in any position between the first rotational position and the second rotational position. The user may not be aware of the relative rotational position of the first connector element 206 when attaching the second connector element 208. This means that the user can attach the second connector element 208 and subsequently find that the first connector element 206 is positioned at the extreme of the range of rotational movement. This may mean that torque can be transmitted from the electrical hose 106 to the main housing 102.

Therefore, the user may need to check the relative rotational position of the first connector element 206 before connecting the second connector element 208. In order to avoid the user needing to check the position of the first connector element 206, in some examples there is rotation biasing mechanism 900.

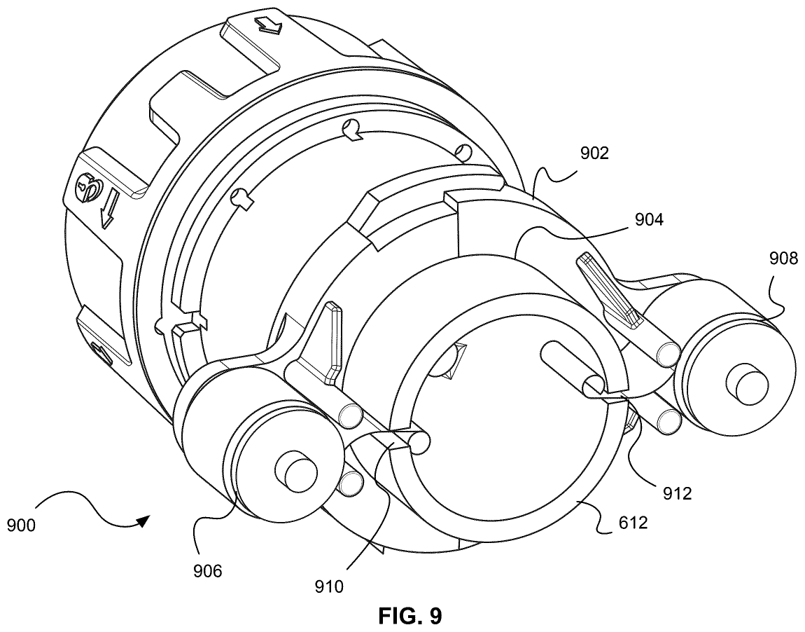

The rotation biasing mechanism 900 is shown in FIG. 9. FIG. 9 shows a perspective view of the rotation biasing mechanism 900. The rotation biasing mechanism 900 is configured to urge the rotatable first connector element 206 to a home position when rotated to a rotated position away from the home position.

The home position is a position of the first connector element 206 which is between the first rotational position shown in FIG. 8A and the second rotational position shown in FIG. 8B. In some examples, the home position is midway between the first rotational position and the second rotational position. In other words, the first connector element 206 can rotate just under 360 degrees in a clockwise direction to the first rotational position and just under 360 degrees in an anticlockwise direction to the second rotational position from the home position.

The first connector element 206 is coupled to the rotation biasing mechanism 900 at the central tube portion 612 of the first connector element 206. The central tube portion 612 is extended in comparison to FIG. 6. All the other components and functionality of the rotatable electrical connector 200 as shown in FIG. 9 are the same as previously described.

The rotation biasing mechanism 900 comprises a frame 902 which is fixed to the main housing 102. The frame 902 does not rotate with respect to the main housing 102. The frame 902 comprises a central aperture 904 for receiving the central tube portion 612. The central tube portion 612 is rotatable with respect to the frame 902 within the central aperture 904.

The rotation biasing mechanism 900 comprises a first roller spring 906 and a second roller spring 908. The first roller spring 906 is coupled to a first slot 910 of the central tube portion 612 and the second roller spring 908 is coupled to a second slot 912 of central tube portion 612.

As the first connection element 206 rotates away from the home position, the first and second roller springs 906, 908 extend and exert an opposing rotational force on the first connection element 206 towards the home position. As the first connection element 206 continues to rotate towards the first or second rotational position, the roller springs wrap around the central tube portion 612.

The first and second roller springs 906, 908 are both configured to extend irrespective of whether the first connection element 206 rotates clockwise or anticlockwise with respect to the main housing 102. This means that the first and second roller springs 906, 908 exert a returning force on the first connector element 206 when rotated away from the home position.

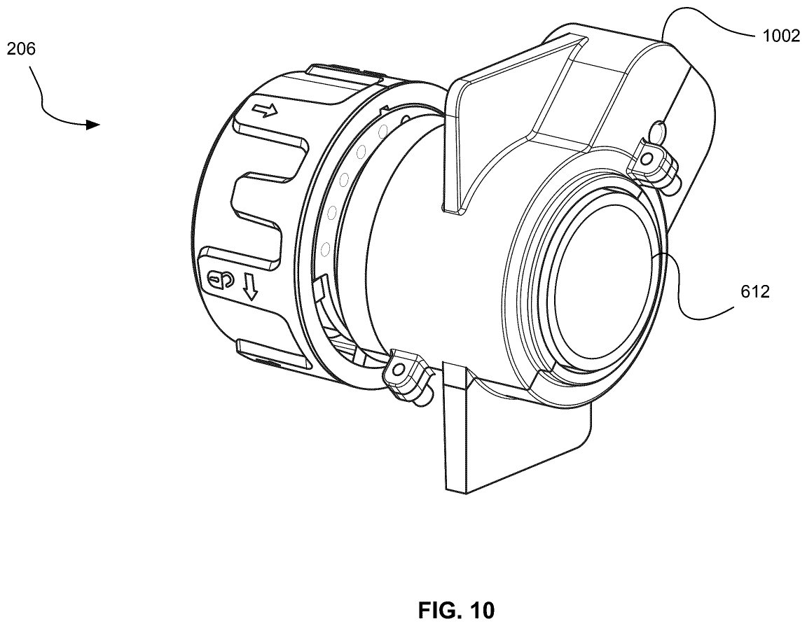

Whilst FIG. 9 shows the first and second roller springs 906, 908, in other examples there is a single roller spring e.g. as shown in FIGS. 10 and 11. It may be preferable to have first and second roller springs 906, 908 coupled to either side of the central tube portion 612 to provide a balanced returning force on the first connector element 206.

FIGS. 10 and 11 show a perspective view of the first connection element 206 with an alternative rotation biasing mechanism 1000. Similar to the rotation biasing mechanism 900 as shown in FIG. 9, the alternative rotation biasing mechanism 1000 is configured to urge the rotatable first connector element 206 to a home position when rotated to a rotated position away from the home position.

It may be preferable to have alternative rotation biasing mechanism 1000 having a single spring coupled to the central tube portion 612 to provide a more compact first connection element 206.

Similar to the example shown in FIG. 9, the home position is a position of the first connector element 206 which is between the first rotational position shown in FIG. 8A and the second rotational position shown in FIG. 8B.

The first connector element 206 is coupled to the alternative rotation biasing mechanism 1000 at the central tube portion 612 of the first connector element 206. The central tube portion 612 is extended in comparison to FIG. 6. All the other components and functionality of the rotatable electrical connector 200 as shown in FIGS. 10 and 11 are the same as previously described.

FIG. 10 shows the alternative rotation biasing mechanism 1000 with a more compact form than the arrangement as shown in FIG. 9. The alternative rotation biasing mechanism 1000 comprises a rotation biasing mechanism housing 1002 mountable to the first connection element 206 which comprises a clamshell assembly.

FIG. 11 shows the alternative rotation biasing mechanism 1000 with the clamshell parts of the rotation biasing mechanism housing 1002 separated to reveal the alternative rotation biasing mechanism 1000.

The alternative rotation biasing mechanism 1000 comprises a spring drum 1004 having a central spiral spring 1006 within the spring drum 1004. The spring drum 1004 is configured to rotate when the central tube portion 612 rotates. A flexible connection band 1008 is connected between the spring drum 1004 and the central tube portion 612.

The flexible connection band 1008 is attached to the central tube portion 612 in a central tube slot 1010. In some examples, the flexible connection band 1008 comprises a crimped band end (not shown) which is configured to be inserted into the central tube slot 1010 via an assembly hole 1014. The crimped band end is held in place by the central tube slot 1010 during operation since the width of the central tube slot 1010 is narrower than the width of the crimped band end.

The flexible connection band 1008 in some examples is a textile band which is configured to wrap around an outside surface 1012 of the spring drum 1004 and the outside of the central tube portion 612 of the first connection element 206.

When the first connection element 206 rotates away from the home position in either rotational direction, the flexible connection band 1008 is configured to wrap around the central tube portion 612 as the flexible connection band 1008 spools off the spring drum 1004. Since the flexible connection band 1008 is able to deform, the flexible connection band 1008 can wrap around the central tube portion 612 when the first connection element 206 and the central tube portion 612 rotates in either direction.

As the flexible connection band 1008 wraps around the central tube portion 612, the spring drum 1004 rotates and the spiral spring 1006 uncoils. This causes the spiral spring 1006 to exert a returning force on the spring drum 1004 and the flexible connection band 1008. The flexible connection band 1008 also exerts the returning force on the central tube portion 612.

When the first connection element 206 is released, the returning force causes the spring drum 1004 to rotate in the opposite direction and cause the flexible connection band 1008 to roll back onto the spring drum 1004. As the flexible connection band 1008 rolls back onto the spring drum 1004, the flexible connection band 1008 will pull the central tube portion 612 and rotate the first connection element 206 towards the home position.

In some other examples, the first and second roller spring 906, 908 can be any suitable type of spring mechanism arranged to exert a returning rotational force.

FIG. 12 shows a side view of a power tool 100 according to another example.

The power tool 100 as shown in FIG. 12 shows a power unit 1220. The power unit 1220 comprises a power source in the main housing 102. The power source can be any suitable power source configured to provide electrical power to the tool device 104. For example, the power source can be one or more battery packs. Additionally or alternatively the power source can be a mains power source.

Similar to FIG. 1B, the power tool 100 as shown in FIG. 12 is again a concrete vibrator 100. The concrete vibrator 100 in FIG. 12 comprises a main housing 102b with a floor mounted frame 110 and a tool device 104. The tool device 104 is not shown in FIG. 12 for the purposes of clarity. However, whilst the example shown in FIG. 12 is discussed with respect to a floor mounted frame 110, the example as shown in FIG. 12 can also be alternatively applied to the power tool 100 mounted to the harness 108 as shown in FIG. 1A.

As shown in FIG. 12, the main housing longitudinal axis 230 extends along the power tool 100. The rotatable electrical connector 200 comprises the connector longitudinal axis 320 which is inclined with respect to the main housing longitudinal axis 230. In some examples, the rotatable electrical connector 200 is the same as discussed with respect to the previous examples. Accordingly, the first rotation axis 220 is coaxial with the connector longitudinal axis 320 and the first rotation axis 220 is also inclined with respect to the main housing longitudinal axis 230.

The power tool 100 as shown in FIG. 12 is placed on a floor surface 1202 with the main housing longitudinal axis 230 parallel or substantially parallel to the floor surface 1202. Whilst the power tool 100 is shown in a substantially horizontal position in FIG. 12, the power tool 100 can also be orientated in a substantially vertical position (not shown). In the vertical position, a short end 1206 of the floor mounted frame 110 rests on the floor surface 1202. Furthermore, optionally, a moveable stabilising foot 1204 slidably mounted to the main housing 102b is extended to also engage the floor surface 1202.

In some examples, the connector angle 1200 is 9.5 degrees as shown in FIG. 12. However, in other examples, the connector angle 1200 can be between 5 degrees to 30 degrees. In other examples, the connector angle 1200 can be 10 degrees, 15 degrees, 20 degrees, 25 degrees, 35 degrees, 40 degrees, 45 degrees or any other suitable connector angle 1200.

By providing the connector angle 1200, this means that the flexible tool connection 106, e.g. the electrical hose 106 is not required to bend as much. This is advantageous because the electrical hose 106 is stiff and therefore, the force required to bend the electrical hose 106 can also cause the power tool 100 to topple over when placed on the floor surface 1202.

As discussed above the example as discussed in FIG. 12 uses the rotatable electrical connector 200. However, in some alternative examples, an alternative electrical connector 1210 is not rotatable about the connector longitudinal axis 320. In this case, the alternative electrical connector 1210 between the main housing 102b and the electrical hose 106 is not configured to decouple torque applied to the tool device 104 or the electrical hose 106 from the main housing 102b as discussed with reference to the examples shown in FIGS. 1 to 11. However, if the connector longitudinal axis 320 of the alternative electrical connector 1210 is inclined with respect to the main housing longitudinal axis 230, the electrical hose 106 is less likely to cause the power tool 100 to topple over when placed on the floor surface 1202.

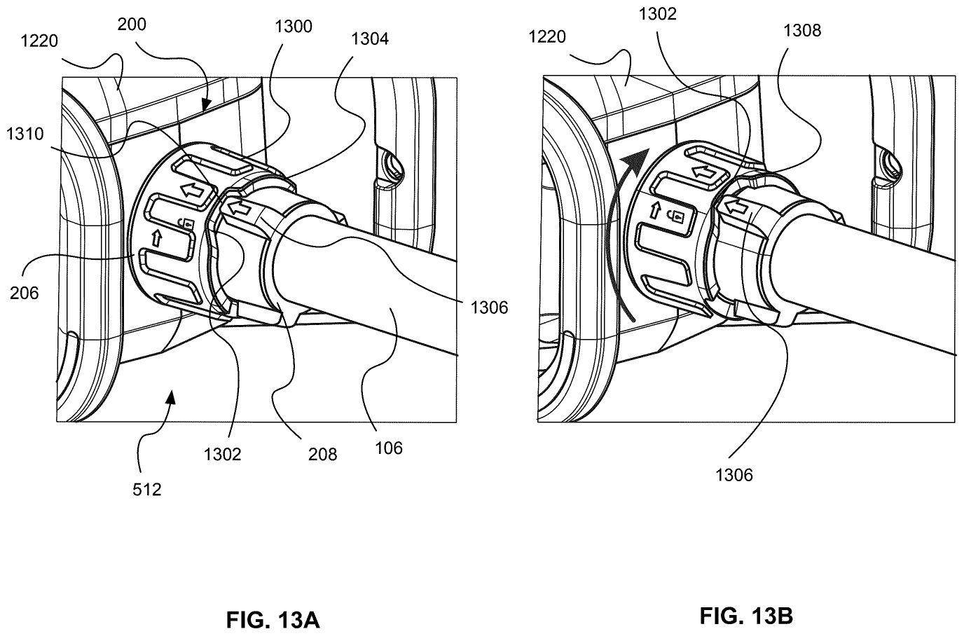

Another example will now be discussed in reference to FIGS. 13a to 13c which respectively show the rotatable electrical connector 200 in different positions. In some examples, the rotatable electrical connector 200 is substantially the same as discussed in reference to the examples shown in FIGS. 1 to 12. However, the locking mechanism 512 between the first connection element 206 and the second connection element 208 has been modified.

The locking mechanism 512 comprises an alternative rotatable locking ring 1300. The alternative rotatable locking ring 1300 as shown in FIG. 13 comprises a similar functionality to the rotatable locking ring 514 as shown in FIGS. 5 and 6. Additionally, the alternative rotatable locking ring 1300 comprises a camming surface 1302 configured to urge the electrical hose 106 away from the rotatable electrical connector 200 when the locking mechanism 512 and the alternative rotatable locking ring 1300 moves from the locking position to the release position.

The periphery 1304 of the alternative rotatable locking ring 1300 extends circumferentially around the alternative rotatable locking ring 1300. The camming surface 1302 is formed by varying the profile of the periphery 1304 of the alternative rotatable locking ring 1300.

The second connection element 208 comprises a projecting finger 1306 with an end surface 1310 configured to engage the camming surface 1302. When the alternative rotatable locking ring 1300 is rotated about the first rotation axis 220 of the rotatable electrical connector 200, the camming surface 1302 of the alternative rotatable locking ring 1300 moves with respect to the projecting finger 1306. The camming surface 1302 as shown in FIG. 13A is not in engagement with the projecting finger 1306. Accordingly, the alternative rotatable locking ring 1300 is in the locking position and the second connection element 208 is secured to the first connection element 206.

The direction of rotation of the alternative rotatable locking ring 1300 with respect to the second connection element 208 is shown in FIG. 13B. As shown in FIG. 13B, the camming surface 1302 is just starting to engage the projecting finger 1306.

As the user continues to rotate the alternative rotatable locking ring 1300, the camming surface 1302 urges the end surface 1310 and the projecting finger 1306 away from the alternative rotatable locking ring 1300. This means that the second connection element 208 is urged away from the first connection element 206. Accordingly, the electrical hose 106 is physically disconnected by rotating the alternative rotatable locking ring 1300. This provides for easier removal of the electrical hose 106 from the main housing 102b of the power tool 100. For example, the user can remove the electrical hose 106 with a single hand and/or remove the electrical hose 106 with a single twist action of the alternative rotatable locking ring 1300.

When the camming surface 1302 engages the projecting finger 1306, the second connection element 208 is urged in a direction away from the first connection element 206 parallel to the connector longitudinal axis 320 as shown in FIG. 13C. In FIG. 13C, the camming surface 1302 has rotated past the projecting finger 1306.

Whilst FIGS. 13A to 13C show one camming surface 1302 and one projecting finger 1306, optionally there can be any suitable number of camming surfaces 1302 and reciprocal projecting fingers 1306. Indeed, in some examples, there are a plurality of camming surfaces 1302 and reciprocal projecting fingers 1306 positioned circumferentially around the alternative rotatable locking ring 1300. In some examples there are three respective camming surfaces 1302 and reciprocal projecting fingers 1306 circumferentially spaced around the alternative rotatable locking ring 1300. Accordingly, this means that the resultant urging force created by the camming surfaces 1302 on the projecting fingers 1306 is in a direction parallel with the connector longitudinal axis 320 rather at an angle with respect to the connector longitudinal axis 320. This makes removal of the second connection element 208 easier from the first connection element 206. However, the alternative rotatable locking ring 1300 is able to urge the second connection element 208 away from the first connection element 206 with only one camming surface 1302 and one projecting finger 1306.

As shown in Figured 13A in some examples optionally there is a stop surface 1308. The stop surface 1308 is inclined steeper compared to the camming surface 1302. This means that the end surface 1310 of the projecting finger 1306 is not able to engage with the stop surface 1308. This means that the stop surface 1308 prevents rotation of the alternative rotatable locking ring 1300 in a direction opposite to that shown in FIG. 13B. This means that the alternative rotatable locking ring 1300 can only move from the locked position to the release position in one rotational direction e.g. as shown in FIG. 13B.

Alternatively, the stop surface 1308 is also profiled similar to the camming surface 1302. In this case, the end surface 1310 of the projecting finger 1306 can engage a camming surface 1302 when the user rotates the alternative rotatable locking ring 1300 in either rotation direction (e.g. the same rotation direction shown in FIG. 13B, or the opposition rotation direction as shown in FIG. 13B).

As discussed above the example as discussed in FIGS. 13A to 13C uses the rotatable electrical connector 200 with an alternative rotatable locking ring 1300. However, in some alternative examples, an alternative electrical connector is not rotatable about the connector longitudinal axis 320. In this case, the electrical connector between the main housing 102b and the electrical hose 106 is not configured to decouple torque applied to the tool device 104 or the electrical hose 106 from the main housing 102b as discussed with reference to the examples shown in FIGS. 1 to 11. However, if the alternative rotatable locking ring 1300 is used with an electrical connector which does not rotate about the first rotation axis 220, the user can still more easily disconnect the electrical hose 106 from the power tool 100 as described above.

Whilst the examples shown in FIGS. 13A to 13C are discussed with respect to a floor mounted frame 110, the examples as shown in FIGS. 13A to 13C can also be alternatively applied to the power tool 100 mounted to the harness 108 as shown in FIG. 1A.

FIGS. 13A to 13C partially show a power unit 1220. The power unit can be coupled to a power source. For example, the power unit 1220 comprises a power source in or couplable to the main housing 102. The power source can be any suitable power source configured to provide electrical power to the tool device 104. For example, the power source can be one or more battery packs. The battery pack(s) can be removably attachable to the main housing of the power unit. Additionally or alternatively the power source can be a mains power source that can be connected to the power unit via a cable.

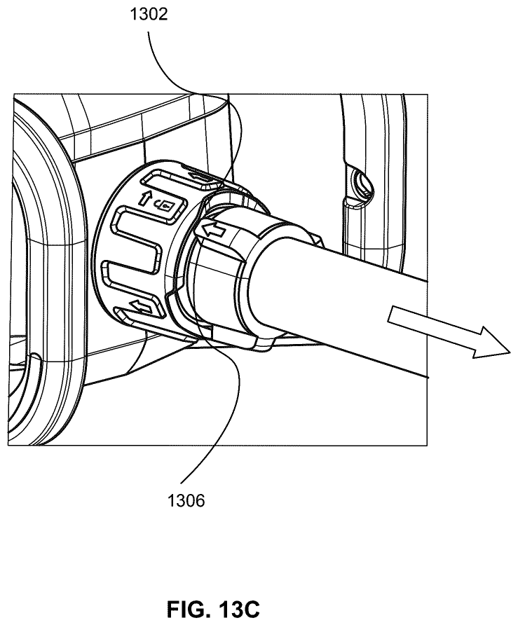

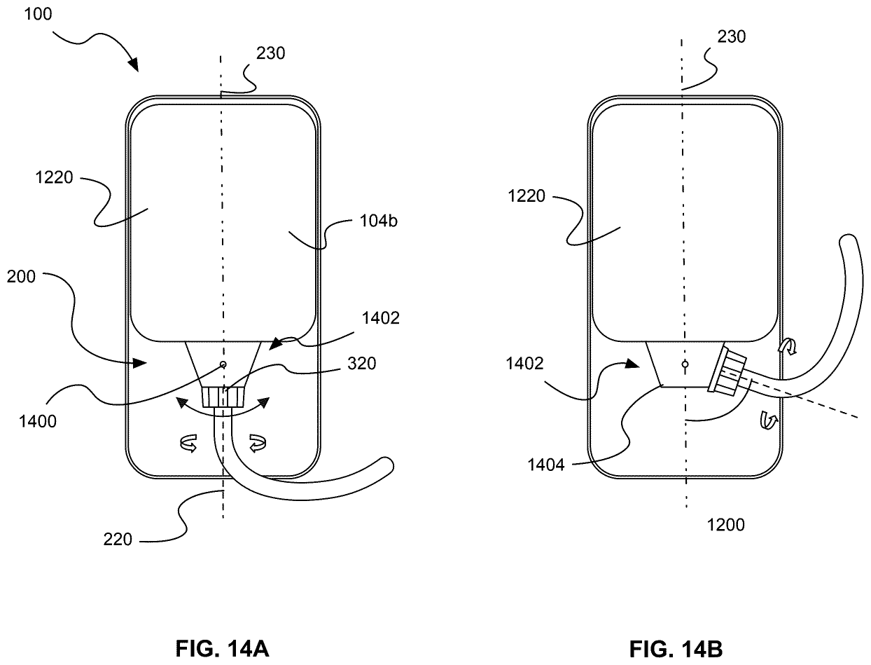

FIGS. 14A and 14B show a side view of the power tool 100 according to another example. In some examples, the rotatable electrical connector 200 is substantially the same as discussed in reference to the examples shown in FIGS. 1 to 12 and 13A to 13C. However, the mounting arrangement of the rotatable electrical connector 200 on the main housing 102b has been modified.

Again, the example in FIGS. 14A and 14B are discussed with respect to a floor mounted frame 110. However, the examples as shown in FIGS. 14A and 14B can also be alternatively applied to the power tool 100 mounted to the harness 108 as shown in FIG. 1A.

FIGS. 14A to 14B show a power unit 1220. The power unit can be coupled to a power source. For example, the power unit 1220 comprises a power source in or couplable to the main housing 102. The power source can be any suitable power source configured to provide electrical power to the tool device 104. For example, the power source can be one or more battery packs. The battery pack(s) can be removably attachable to the main housing of the power unit. Additionally or alternatively the power source can be a mains power source that can be connected to the power unit via a cable.

As mentioned above, the rotatable electrical connector 200 is rotatable about the first rotation axis 220. In addition, the examples as shown in FIGS. 14A and 14B allow the rotatable electrical connector 200 to pivot about a connector pivot axis 1400. In this example, the connector pivot axis 1400 is arranged substantially perpendicular to the first rotation axis 220, the connector longitudinal axis 320 and the main housing longitudinal axis 230.

At the same time, the connector pivot axis 1400 is also perpendicular to a longitudinal axis of the flexible tool connection 106 when connected to the rotatable electrical connector 200.

FIG. 14A shows the rotatable electrical connector 200 in a position where the first rotation axis 220 is in line with the main housing longitudinal axis 230. The rotatable electrical connector 200 is the same as discussed with respect to the previous examples in that the first connection element 206 and the second connection element 208 can rotate with respect to each other, which decouples the torque on the electrical hose 106 from the main housing 102b. In other words, the connector angle 1200 is 0 degrees as shown in FIG. 14A.

FIG. 14B shows that the rotatable electrical connector 200 having rotated about the connector pivot axis 1400 so that the first rotation axis 220 and the connector longitudinal axis 320 are inclined with respect to the main housing longitudinal axis 230. Again, when the rotatable electrical connector 200 has pivoted, the first connection element 206 and the second connection element 208 can still rotate with respect to each other.

Accordingly, the rotatable electrical connector 200 is pivotable about the connector pivot axis 1400 in which connector longitudinal axis 320 forms a first angle with respect to the main housing longitudinal axis 230 and a second position in which the connector longitudinal axis 320 forms a second, different, angle with respect to the main housing longitudinal axis 230.

In FIG. 14B the connector pivot axis 1400 is shown with a connector angle 1200 with approximately 60 degrees. However, the connector pivot axis 1400 is configured to permit the connector angle 1200 to vary over a range of angles. For example, the connector angle 1200 can vary between +90 degrees and −90 degrees. This means that the rotatable electrical connector 200 can pivot either in a first pivoting direction and a second pivoting direction as shown in FIG. 14A.

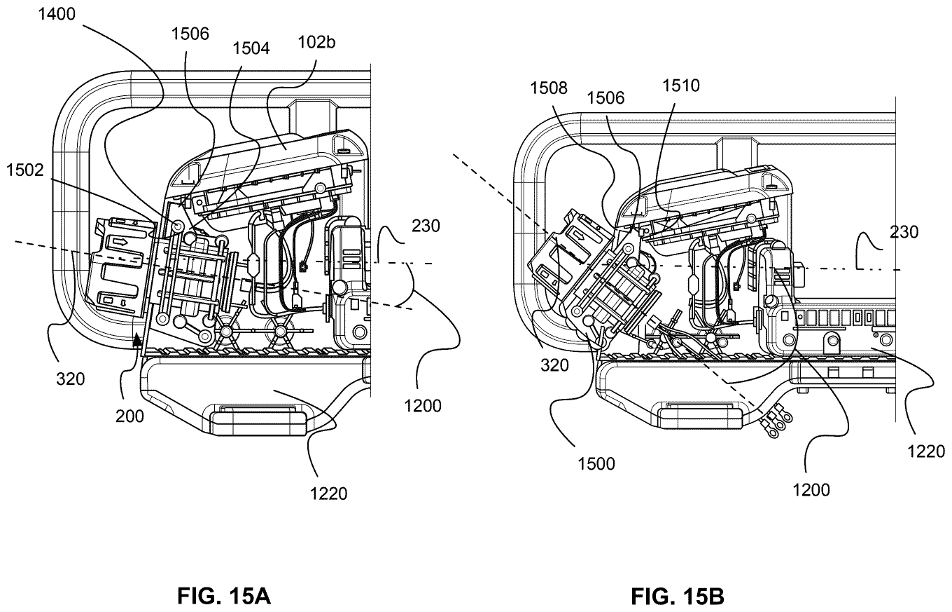

The range of the pivoting of the rotatable electrical connector 200 is determined by the mounting arrangement of the rotatable electrical connector 200 on the main housing 102b. In some examples the range of the connector angle 1200 can be smaller e.g. −15 degrees to +15 degrees, −20 degrees to +20 degrees, −30 degrees to +30 degrees, −45 degrees to +45 degrees, −60 degrees to +60 degrees, −75 degrees to +75 degrees etc. In some examples the range of the connector angle 1200 can be larger e.g. −100 degrees to +100 degrees, −110 degrees to +110 degrees, −120 degrees to +120 degrees etc. Furthermore, the rotatable electrical connector 200 may have a range of movement which is not symmetrical e.g. 0 degrees to +15 degrees, 0 degrees to 20 degrees, 0 degrees to +30 degrees, 0 degrees to +45 degrees, 0 degrees to +60 degrees, 0 degrees to 75 degrees, 0 degrees to 100 degrees, 0 degrees to 110 degrees, 0 degrees to 120 degrees etc., Furthermore, the range of movement can start from an already inclined arrangement as shown in e.g. FIG. 12. In this way the rotatable electrical connector 200 may have a range of movement of +10 degrees to +15 degrees, +10 degrees to +20 degrees, +10 degrees to +30 degrees, +10 degrees to +45 degrees, +10 degrees to +60 degrees, +10 degrees to 75 degrees, +10 degrees to 100 degrees, +10 degrees to 110 degrees, +10 degrees to 120 degrees etc. This is further shown in FIGS. 15A and 15B described below.

In some examples, the main housing 102b comprises a yoke 1402 configured to rotatably mount the rotatable electrical connector 200 about the connector pivot axis 1400. The yoke 1402 engages either side of the rotatable electrical connector 200 whereby a first and second pivot pin (not shown) aligned with the connector pivot axis 1400 engage with the first connection element 206. The first connection element 206 is the pivotable about the connector pivot axis 1400. When the first connection element 206 is coupled to the second connection element 208, pivotable movement of the first connection element 206 causes pivotable movement of the whole rotatable electrical connector 200.

The yoke 1402 as shown in FIGS. 14A and 14B comprises a first yoke arm 1404 and a second yoke arm (not shown). The first yoke arm 1404 and the second yoke arm are configured to rotatably mount the rotatable electrical connector 200 therebetween. The rotatable electrical connector 200 is pivotable about the connector pivot axis 1400 without the first connection element 206 or the second connection element 208 colliding with the first or second yoke arms 1404.

As discussed above the example as discussed in FIGS. 14A and 14B uses the rotatable electrical connector 200 which is pivotable about the connector pivot axis 1400. However, in some alternative examples, an alternative electrical connector is not rotatable about the connector longitudinal axis 320. In this case, the electrical connector between the main housing 102b and the electrical hose 106 is not configured to decouple torque applied to the tool device 104 or the electrical hose 106 from the main housing 102b as discussed with reference to the examples shown in FIGS. 1 to 11. However, an electrical connector which does not rotate about the first rotation axis 220 can be pivotably mounted to the main housing 102b. In this case, the connector longitudinal axis 320 of an alternative electrical connector can still pivot with respect to the main housing longitudinal axis 230 as shown in FIGS. 14A and 14B.

By pivotably mounting the rotatable electrical connector 200 to the main housing 102b, this means that the flexible tool connection 106, e.g. the electrical hose 106 is not required to bend much. This advantageously avoids the stiff electrical hose 106 causing the power tool 100 to topple over when placed on the floor surface 1202. Accordingly, the rotatable electrical connector 200 can pivot about the connector pivot axis 1400 instead and the power tool 100 is less likely to topple when placed on the floor surface 1202.

FIGS. 15A and 15B show a partial close-up side cross-sectional view of the power tool 100 according to the arrangements respectively shown in FIGS. 14A and 14B. As mentioned above, the main housing longitudinal axis 230 extends along the power tool 100. The rotatable electrical connector 200 as shown in FIG. 15A comprises the connector longitudinal axis 320 which is inclined with respect to the main housing longitudinal axis 230. This is a similar arrangement to that shown in FIG. 12. However, in some arrangements, the rotatable electrical connector 200 comprises the connector longitudinal axis 320 which is in line with respect to the main housing longitudinal axis 230.

The rotatable electrical connector 200 as shown in FIGS. 15A and 15B is pivotable about the connector pivot axis 1400 between the first position of the rotatable electrical connector 200 as shown in FIG. 15A and the second position of the rotatable electrical connector 200 as shown in FIG. 15B. Accordingly, in some examples, the rotatable electrical connector 200 is pivotable between a range of e.g. 40 degrees. As discussed above, this can be varied, if required.

As shown in FIGS. 15A and 15B the connector pivot axis 1400 is positioned on one side of the rotatable electrical connector 200. A pivot pin 1502 is aligned along the connector pivot axis 1400 and protrudes through a reciprocal pivot hole 1504 on a projecting flange 1506 of the rotatable electrical connector 200.

In some examples, e.g. as shown in FIGS. 15A and 15B, the range of pivotal movement of the rotatable electrical connector 200 about the connector pivot axis 1400 is limited by the extent of movement that the projecting flange 1506 within the main housing 102b. In some examples, the projecting flange 1506 engages a first housing stop surface 1508 when the rotatable electrical connector 200 is in the first position e.g. as shown in FIG. 15A. In some examples, the projecting flange 1506 engages a second housing stop surface 1510 when the rotatable electrical connector 200 is in the second position e.g. as shown in FIG. 15B.

In some examples, the power unit 1220 comprises a flexible bellow 1500 to cover the rotatable electrical connector 200 when it pivots between the first and second positions as shown in FIGS. 15A and 15B.

As shown in FIGS. 15A and 15B, the main housing longitudinal axis 230, the connector pivot axis 1400 and the connector longitudinal axis 320 are aligned in the same plane. However, in some examples, the connector longitudinal axis 320 is pivotable from a first position to a second position by a first angle with respect to the main housing longitudinal axis in a first plane and a second angle with respect to main housing longitudinal axis in a second plane. In this case, the rotatable electrical connector 200 is mounted to the main housing 102b with e.g. a ball and socket joint or a swivel joint with multiple pivoting axes (not shown). This can allow sideways and forwards and back movement of the rotatable electrical connector 200 with respect to the main housing 102b.

In another example, two or more examples are combined. Features of one example can be combined with features of other examples.

Examples of the present disclosure have been discussed with particular reference to the examples illustrated. However, it will be appreciated that variations and modifications may be made to the examples described within the scope of the disclosure.

1. A power tool comprising:
a main housing comprising an electrical power source;
a tool device comprising at least one electrical component;
a flexible tool connection connected between the main housing and the tool device, the flexible tool connection comprising at least one electrical wire configured to electrically connect the electrical power source and the at least one electrical component; and
a rotatable electrical connector between the main housing and the flexible tool connection, wherein the rotatable electrical connector is configured to decouple torque applied to the tool device or the flexible tool connection from the main housing.

2. The power tool according to claim 1, wherein the flexible tool connection is a hose, a cable, or a tube.

3. The power tool according to claim 1, wherein the rotatable electrical connector comprises a first connector element rotatably mounted on the main housing and a second connector element coupled to the flexible tool connection.

4. The power tool according to claim 3, wherein the first connector element is a socket and the second connector element is a plug.

5. The power tool according to claim 3, wherein the first connector element and the second connector element are configured to connect together in a plurality of different connection orientations.

6. The power tool according to claim 3, wherein the second connector element comprises an alignment pin for engaging with at least one reciprocal alignment channel in the first connector element.

7. The power tool according to claim 3, wherein the first connector element and the second connector element are configured to connect together in a plurality of different connection orientations, and
wherein the first connector element comprises a plurality of different reciprocal alignment channels and each alignment channel corresponds to a different connection orientation of the first and second connector elements.

8. The power tool according to claim 3, wherein the rotatable electrical connector comprises a locking mechanism moveable between a locking position and a release position for selectively securing the first and second connector elements.

9. The power tool according to claim 8, wherein the locking mechanism comprises a rotatable locking ring mounted on the first connector element moveable between the locking position and the release position.

10. The power tool according to claim 9, wherein the rotatable locking ring comprises at least one locking ball and the second connector element comprises an annular recess configured to engage the at least one locking ball and the rotatable locking ring prevents the locking ball moving out of the annular recess when in the locking position.

11. The power tool according to claim 9, wherein the rotatable locking ring is biased to the locking position.

12. The power tool according to claim 3, wherein at least one rotatable bushing is rotatably mounted between the first connector element and the main housing.

13. The power tool according to claim 12, wherein the at least one rotatable bushing comprises a plurality of rotatable bushings mounted between the first connector element and the main housing.

14. The power tool according to claim 12, wherein the at least one rotatable bushing is configured to limit relative rotation of the first connector element with respect to the main housing.

15. The power tool according to claim 12, wherein the at least one rotatable bushing comprises at least one first rotation stop configured to engage a connector stop fixed with respect to the first connector element and at least one second rotation stop configured to engage a sleeve stop fixed with respect to the main housing.

16. The power tool according to claim 15, wherein the at least one first rotation stop is configured to engage the connector stop and the at least one second rotation stop is configured to engage the sleeve stop in a first rotational position and the at least one first rotation stop is configured to engage the connector stop and the at least one second rotation stop configured to engage the sleeve stop in a second rotational position.

17. The power tool according to claim 16, wherein the first connector element is rotatable with respect to the main housing up to 720 degrees about a rotational axis when moving between the first rotational position and the second rotational position.

18. The power tool according to claim 3, wherein the rotatable electrical connector comprises a rotation biasing mechanism configured to urge the rotatable first connector element to a home position when rotated to a rotated position away from the home position.

19. The power tool according to claim 18, wherein the rotation biasing mechanism is mounted between the first connector element and the main housing and comprises at least one spring configured to urge the rotatable first connector element to the home position when the first connector element is rotated in first and second rotational directions.

20. The power tool according to claim 18, wherein the at least one spring is a first spring and a second spring mounted on opposite sides of the first connector element.

21. The power tool according to claim 19, wherein the at least one spring is a roller spring, a spiral spring, and/or a textile band.

22. The power tool according to claim 1, wherein the power tool is a concrete vibrator.
